(19) United States
(12) Patent Application Publication
(10) Pub. No.: US 2009/0049726 A1
(43) Pub. Date: Feb. 26, 2009

(54) Versatile clip holder

(76) Inventor: Randy D. Jenkins, Frankfort, IN (US)

Correspondence Address: RANDY D. JENKINS, 2101 WILSHIRE DR., FRANKFORT, IN, 46041, US

(21) Appl. No.: 11/895,660

(22) Filed: Aug. 25, 2007

(51) Int. Cl. G09F 3/20; G09F 15/00

(52) U.S. Cl. 40/658; 40/607.15

(57) ABSTRACT

One embodiment of a flat piece of rigid material shaped to attach to an existing yard. The base of the rounded horizontal shaped part at bottom, will allow clip to slip onto an angle iron yard sign

The v shaped members will spread apart to allow a small topper sign to be slid down on top of the existing sign for further advertising.

### CROSS-REFERENCE TO RELATED APPLICATIONS

This application claims the benefit of a patent application.

### FEDERALLY RESPONSORED RESEARCH

Not Applicable

### BACKGROUND—FIELD OF INVENTION

This invention is related to Real Estate, or yard Signs.

### BACKGROUND

Real Estate people, (but not limited to) use a sign made of angle iron steel for yard signs, also used is a so-called topper sign.

A topper Sign comes in various sizes ranges from 24 inches in length to 36 inches and 6 inches high.

Therefore there are several types of yard signs used, the topper signs displays the information as to the name and phone numbers and sold or sale pending or other advertising.

This clip will allow a topper sign to be placed on top of the stationary yard sign name or other information.

Although this clip is easy to use and put in place and inexpensive to manufacture, it will not damage the Existing sign or the topper sign.

Clips can be manufactured in various colors, although a hole is provided to accommodate and can be put on an assembly line for powder coating if desired.

### SUMMARY

In accordance with one embodiment the clip is compromised of a flat piece of rigid material shaped to accommodate and hold the smaller signs.

### BRIEF DESCRIPTION OF DRAWINGS

FIG. 1 is a frontal view showing the separating members 1 of the versatile clip holder and hole 2 to accommodate the application of coating, if desired.

FIG. 2 is the side view of the versatile clip holder showing the separating members 1 and the fastening member 3 for mounting onto a sign.

FIG. 3 is a perspective view of the versatile clip holder.

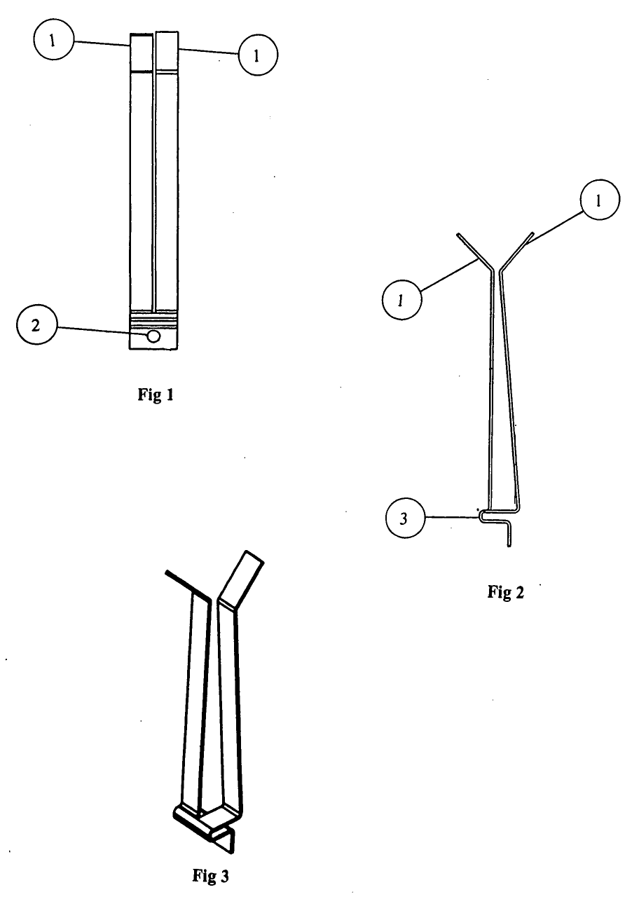

I claim:

1. A new use comprising”
(A) This will allow a secondary sign to be placed on top of a yard (topper) sign for additional advertising.
(B) Provided bottom, fastening member is shaped to accommodate and slip onto the stationary sign, the separating members will spread apart, to accommodate the smaller sign on top.
(C) The hole is provided to for a hanger to be placed on a line If desired .for factory powder coating.
(E) “Whereby” this method will allow additional signage to be sign placed onto the stationary for separate lettering.
